(19) United States
(12) Patent Application Publication
(10) Pub. No.: US 2016/0279996 A1
(43) Pub. Date: Sep. 29, 2016

(54) PIECE WINDING DEVICE

(71) Applicant: MAX CO., LTD., Chuo-ku, Tokyo (JP)

(72) Inventors: Hiroaki TAKAHASHI, Tokyo (JP); Yusuke KUDO, Tokyo (JP)

(21) Appl. No.: 15/032,796

(22) PCT Filed: Oct. 28, 2014
(86) PCT No.: PCT/JP2014/078669

§ 371 Date: Apr. 28, 2016

(30) Foreign Application Priority Data
Oct. 30, 2013 (JP) 2013-225349
Apr. 23, 2014 (JP) 2014-089403

(51) Int. Cl. B42B 5/00

(52) U.S. Cl. CPC B42B 5/00

(57) ABSTRACT

A piece winding device is configured to rotate, when a winding part winds a piece around a sheet having a hole, such that a front end portion of the winding part moves from an end portion of the sheet to the hole of the sheet while the winding part presses the piece and thus the piece attached to one surface of the sheet having the hole is wound from the one surface to the other surface of the sheet and is inserted into the hole from the other surface of the sheet, thereby winding the piece around the sheet having the hole.

### TECHNICAL FIELD

The present invention relates to a piece winding device for winding a piece around a sheet having a hole.

### BACKGROUND ART

There is a binding tool for binding documents with a tape rather than a metal needle (see Patent Literature 1) during binding of the documents. In the binding tool disclosed in Patent Literature 1, for example, papers can be bound with a tape in such a manner that after a paper end is pressed against a release waiting tape during insertion of the papers and then the tape is stuck to the paper end, a punching blade is penetrated into the papers, and an end portion of the tape stuck to the paper end is penetrated into the papers with the withdrawal of the punching blade.

In the binding tool disclosed in Patent Literature 1, however, when the papers are, for example, thin, the paper end is bent to cause wrinkles or damage when the paper end is pressed against the release waiting tape by the insertion of the papers and thus the tape is stuck to the paper end. Accordingly, such a binding tool is not suitable for thin papers and has a possibility of not binding reliably the papers with the tape. In the binding tool disclosed in Patent Literature 1, furthermore, since an adhesive layer is waiting in a state of being exposed by the release of the tape, there are concerns that adhesive strength of the tape is reduced and the papers cannot be reliably bound with the tape when the binding tool is used after being waited for a long period of time. Since there is no gap between a hole opened in the paper and the punching blade when the tape passes through the papers using the punching blade, the tape is actively pressed against the papers, and thus an adhesive surface is stuck to the papers. Since the tape passes through the papers against the sticking force, a load required for insertion of the tape is large, and since the adhesive surface is scraped, the adhesive strength also decreases.

### CITATION LIST

### Patent Literature

[Patent Literature 1] JP-A-H10-000871

### SUMMARY OF INVENTION

The present invention is made in consideration of the above problems and an object thereof is to provide a piece winding device capable of reliably winding a piece around a sheet.

A piece winding device according to the present invention is configured to wind a piece attached to one surface of a sheet having a hole so as to wind the piece from the one surface to the other surface of the sheet and to insert the piece into the hole from the other surface of the sheet.

In addition, a piece winding device according to the present invention includes a winding part that, when winding a piece around a sheet having a hole, rotates such that a front end portion of the winding part moves from an end portion of the sheet to the hole of the sheet while the front end portion presses the piece.

The winding part may be provided to be movable from one surface to the other surface of the sheet, and after winding the piece attached to the one surface of the sheet from the one surface to the other surface of the sheet, the winding part may move from the one surface of the sheet to the other surface to insert the piece into the hole from the other surface of the sheet.

The winding part may be provided to be movable from one surface to the other surface of the sheet, and the winding part may be configured to wind the piece attached to the one surface of the sheet from the one surface to the other surface of the sheet to insert the piece into the hole from the other surface of the sheet while the winding part moves from the one surface to the other surface of the sheet.

The piece may have an adhesive layer.

The piece winding device may further include a positioning member by which the sheet is positioned.

The piece winding device may further include a pressing member that presses the sheet wound with the piece.

In addition, a piece winding device according to the present invention includes a winding part that, when winding a piece around a sheet having a hole, rotates such that a front end portion of the winding part moves from the hole of the sheet to an end portion of the sheet while the front end portion presses the piece.

The piece winding device may further include another winding part that rotates such that a front end portion of said another winding part moves from the end portion of the sheet to the hole of the sheet while said another winding part presses the piece.

### ADVANTAGEOUS EFFECTS OF INVENTION

According to the present invention, the winding part rotates when winding the piece around the sheet having the hole such that the front end portion of the winding part moves to the hole of the sheet from the end portion of the sheet while pressing the piece, and thus the piece attached to one surface of the sheet is wound from the one surface to the other surface of the sheet and is inserted into the hole from the other surface of the sheet, thereby winding the piece around the sheet having the hole. Therefore, the piece can be reliably wound around the sheet with neat finishing without wrinkles or bending damage even in any kind of sheet. In addition, since a hole-boring means and a means to pass a tape through a hole are different from each other, a load required for insertion of the tape into the paper hole is small, and adhesive strength of the tape does not also decrease.

### BRIEF DESCRIPTION OF DRAWINGS

FIG. 1A illustrates a state where a piece is wound around a sheet having a hole, and FIG. 1A is a perspective view as seen from one surface of the sheet.

FIG. 1B illustrates the state where the piece is wound around the sheet having the hole, and FIG. 1B is a plan view as seen from one surface of the sheet.

FIG. 1C illustrates the state where the piece is wound around the sheet having the hole, and FIG. 1C is a perspective view as seen from the other surface of the sheet.

FIG. 1D illustrates the state where the piece is wound around the sheet having the hole, and FIG. 1D is a cross-sectional view.

FIG. 2A is a plan view illustrating a strip-like body.

FIG. 2B is a cross-sectional view illustrating the strip-like body.

FIG. 2C is an enlarged cross-sectional view illustrating a state where a piece is placed on a pedestal.

FIG. 3A illustrates a winding part, and FIG. 3A is a cross-sectional view illustrating a waiting state.

FIG. 3B illustrates the winding part, and FIG. 3B is a cross-sectional view illustrating a state at the time of winding.

FIG. 4 is a cross-sectional view illustrating a piece winding device according to the present invention.

FIG. 5 is a cross-sectional view illustrating a state where a sheet is placed on a pedestal.

FIG. 6 is a cross-sectional view illustrating a state where a piece released from a release paper is fed toward a pedestal.

FIG. 7 is a cross-sectional view illustrating a state the other end portion of a piece is wound to the other surface from one surface of a sheet by a winding part and thus is inserted into a hole of the sheet from the other surface of the sheet.

FIG. 8 is a cross-sectional view illustrating a state where the winding part returns to a waiting position.

FIG. 9 is a cross-sectional view illustrating a state where a sheet wound with a piece is pulled out.

FIG. 10 is a cross-sectional view illustrating a state where a sheet and a piece are pressed against a pedestal by a pressing portion and thus the piece is attached to the sheet.

FIG. 11A illustrates a piece winding device according to a first modification example in which a winding part is made up of two members, and FIG. 11A is a cross-sectional view illustrating a waiting state.

FIG. 11B illustrates the piece winding device according to the first modification example in which the winding part is made up of two members, and FIG. 11B is a cross-sectional view illustrating a state at the time of start of winding.

FIG. 11C illustrates the piece winding device according to the first modification example in which the winding part is made up of two members, and FIG. 11C is a cross-sectional view illustrating a state at the time of completion of winding.

FIG. 12A illustrates a piece winding device according to a third modification example, and FIG. 12A is a cross-sectional view illustrating a waiting state.

FIG. 12B illustrates the piece winding device according to the third modification example, and FIG. 12B is a cross-sectional view illustrating a state at the time of winding.

FIG. 13A illustrates a piece winding device according to a fourth modification example, and FIG. 13A is a cross-sectional view illustrating a waiting state.

FIG. 13B illustrates the piece winding device according to the fourth modification example, and FIG. 13B is a cross-sectional view illustrating a state at the time of winding.

FIG. 14A illustrates a piece winding device according to a fifth modification example, and FIG. 14A is a cross-sectional view illustrating a waiting state.

FIG. 14B illustrates the piece winding device according to the fifth modification example, and FIG. 14B is a cross-sectional view illustrating a state at the time of winding.

FIG. 15A illustrates a piece winding device according to a sixth modification example in which a piece is wound around a sheet having a hole by a first winding part and a second winding part, and FIG. 15A is a cross-sectional view illustrating a waiting state.

FIG. 15B illustrates the piece winding device according to the sixth modification example in which the piece is wound around the sheet having the hole by the first winding part and the second winding part, and FIG. 15B is a cross-sectional view illustrating a state where the piece is wound around the sheet by the first winding part.

FIG. 15C illustrates the piece winding device according to the sixth modification example in which the piece is wound around the sheet having the hole by the first winding part and the second winding part, and FIG. 15C is a cross-sectional view illustrating a state where the piece is wound around the sheet by the second winding part.

FIG. 15D illustrates the piece winding device according to the sixth modification example in which the piece is wound around the sheet having the hole by the first winding part and the second winding part, and FIG. 15D is a cross-sectional view illustrating a modification example of FIG. 15B.

FIG. 16A illustrates a piece winding device according to a seventh modification example in which a winding part is provided to be movable from one surface to the other surface of a sheet, and FIG. 16A is a cross-sectional view illustrating a waiting state.

FIG. 16B illustrates the piece winding device according to the seventh modification example in which the winding part is provided to be movable from the one surface to the other surface of the sheet, and FIG. 16B is a cross-sectional view illustrating a state where the winding part is moved to the other surface from the one surface of the sheet.

FIG. 16C illustrates the piece winding device according to the seventh modification example in which the winding part is provided to be movable from the one surface to the other surface of the sheet, and FIG. 16C is a cross-sectional view illustrating a state where the piece is wound around the sheet by the winding part.

FIG. 17A illustrates a piece winding device according to a further modification example of the seventh modification example in which a winding part winds a piece from one surface to the other surface of a sheet while moving the one surface to the other surface, and FIG. 17A is a cross-sectional view illustrating a waiting state.

FIG. 17B illustrates the piece winding device according to the further modification example of the seventh modification example in which the winding part winds the piece from the one surface to the other surface of the sheet while moving the one surface to the other surface, and FIG. 17B is a cross-sectional view illustrating a state where the piece is wound around the sheet by the winding part.

FIG. 17C illustrates the piece winding device according to the further modification example of the seventh modification example in which the winding part winds the piece from the one surface to the other surface of the sheet while moving the one surface to the other surface, and FIG. 17C is a cross-sectional view illustrating a state where the piece is wound around the sheet by the winding part.

FIG. 18A illustrates a piece winding device according to an eighth modification example in which a winding part rotates such that a front end portion moves to an end portion of a sheet from a hole of the sheet while pressing a piece, and FIG. 18A is a cross-sectional view illustrating a waiting state.

FIG. 18B illustrates the piece winding device according to the eighth modification example in which the winding part rotates such that the front end portion moves to the end portion of the sheet from the hole of the sheet while pressing the piece, and FIG. 18B is a cross-sectional view illustrating a state where the piece is wound around the sheet by the winding part.

FIG. 18C illustrates the piece winding device according to the eighth modification example in which the winding part rotates such that the front end portion moves to the end portion of the sheet from the hole of the sheet while pressing the piece, and FIG. 18C is a cross-sectional view illustrating a state where the piece is wound around the sheet by the winding part.

FIG. 19A illustrates a piece winding device according to a further modification example of the eighth modification example including a first winding part and a second winding part which are different in a rotation direction from each other, and FIG. 19A is a cross-sectional view illustrating a waiting state.

FIG. 19B illustrates the piece winding device according to the further modification example of the eighth modification example including the first winding part and the second winding part which are different in a rotation direction from each other, and FIG. 19B is a cross-sectional view illustrating a state where the piece is wound around the sheet by the second winding part.

FIG. 19C illustrates the piece winding device according to the further modification example of the eighth modification example including the first winding part and the second winding part which are different in a rotation direction from each other, and FIG. 19C is a cross-sectional view illustrating a state where the piece is wound around the sheet by the first winding part.

### DESCRIPTION OF EMBODIMENTS

Referring to the accompanying drawings, a piece winding device according to the present invention will be described in detail. The present invention is not intended to be limited only by the following examples, and appropriate modifications may be made within the scope not departing from the gist of the present invention.

<1. Description of Configuration of Piece Winding Device>

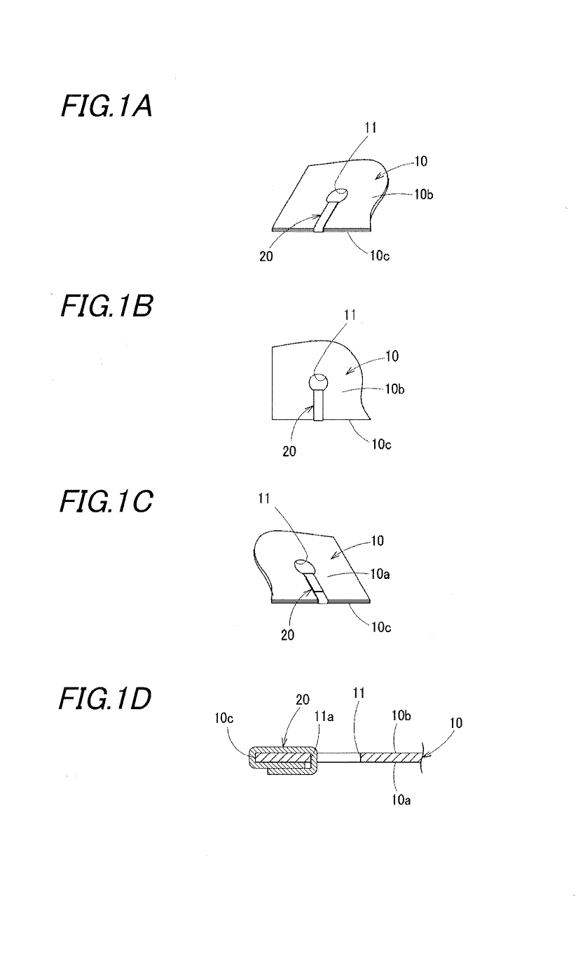

As illustrated in FIGS. 1A to 1D, for example, a piece winding device 1 according to the present invention is configured to wind a piece 20, which is attached to one surface 10a of a sheet 10 having a hole 11, to the other surface 10b from the one surface 10a of the sheet 10, and to wind the piece 20 around the sheet 10 having the hole 11 by inserting the piece 20 into the hole 11 of the sheet 10 from the other surface 10b of the sheet 10.

In this way, since the piece winding device 1 can be configured to bind the sheet 10 using the piece 20 by winding the piece 20 around the sheet 10 having the hole 11, the piece winding device 1 can be used as, for example, a binding device for binding the sheet 10. In addition, since the piece winding device 1 can be configured to reinforce the hole 11 of the sheet 10 using the piece 20 by winding the piece 20 around the sheet 20 having the hole 11, the piece winding device 1 can be used as, for example, a reinforcing tool attaching device for attaching a reinforcing tool (piece 20) to the sheet 10 having the hole 11. Furthermore, the piece winding device 1 can identify the sheet 10 using the piece 20 by, for example, winding the piece 20 in different colors or the piece 20 marked with different indicia around the sheet 10 having the hole 11. Therefore, the piece winding device 1 can be used as, for example, an identification tool attaching device for attaching an identification tool (piece 20) to the sheet 10 having the hole 11.

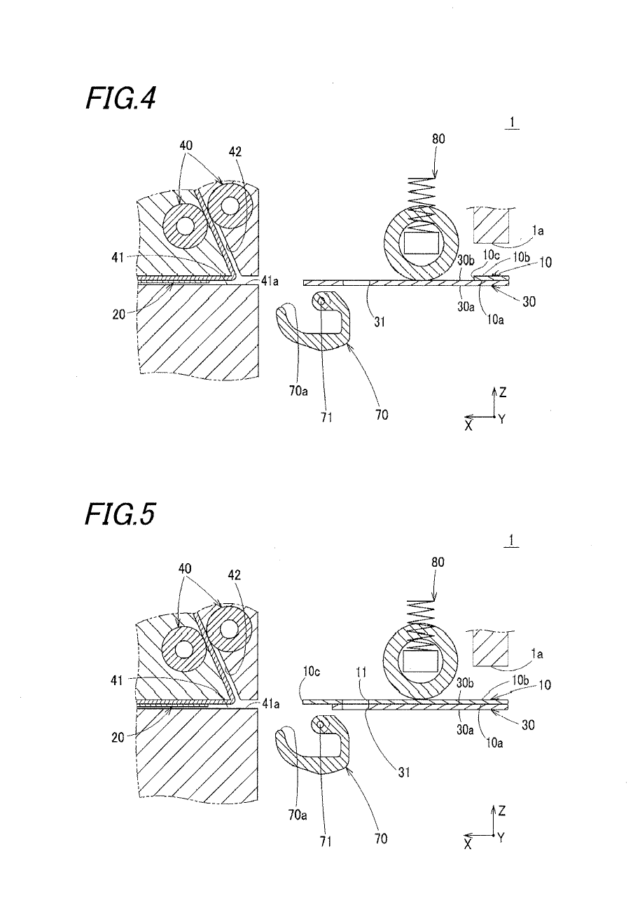

Specifically, the piece winding device 1 includes a pedestal 30 in which the sheet 10 inserted from a sheet insertion port la is placed on the other surface 30b, as illustrated in FIG. 4.

The piece winding device 1 further includes a piece feeding portion 40 which is disposed at a back side farther than the pedestal 30 in a sheet insertion direction X to feed the piece 20 such that a part thereof overlaps with an end on an insertion end side of the sheet 10.

The piece winding device 1 further includes a winding part 70 which is disposed on one surface 30a of the pedestal 30 and is rotatably provided on the back side in the sheet insertion direction X to wind the piece 20 around the sheet 20 having the hole 11.

The piece winding device 1 further includes a pressing portion 80 which is disposed on the other surface 30b of the pedestal 30 to press the sheet 10 around which the piece 20 is wound by the winding part 70.

As FIGS. 1A to 1D, the sheet 10 is made up of, for example, papers such as documents, or a sheet-like member formed of a metal material, a resin material, or the like. Further, the hole 11 is formed in the vicinity of the end on the insertion end side of the sheet 10 to penetrate in a thickness direction. The hole 11 may be a punched hole formed in the sheet 10 by a punch portion (not illustrated) after the sheet 10 is inserted into the piece winding device 1, or a through-hole such as a punched hole formed in the sheet 10 by a separate punching device or the like in advance before the sheet 10 is inserted into the piece winding device 1.

The sheet 10 is circumferentially wound once by the piece 20 over the one surface 10a, an end face 10c on the insertion end side, the other surface 10b, and a hole-edge end face 11a of the hole 11. At this time, a plurality of sheets 10 may be wound by the piece 20 in a state of being overlapped with each other, and only one sheet may be wound by the piece 20.

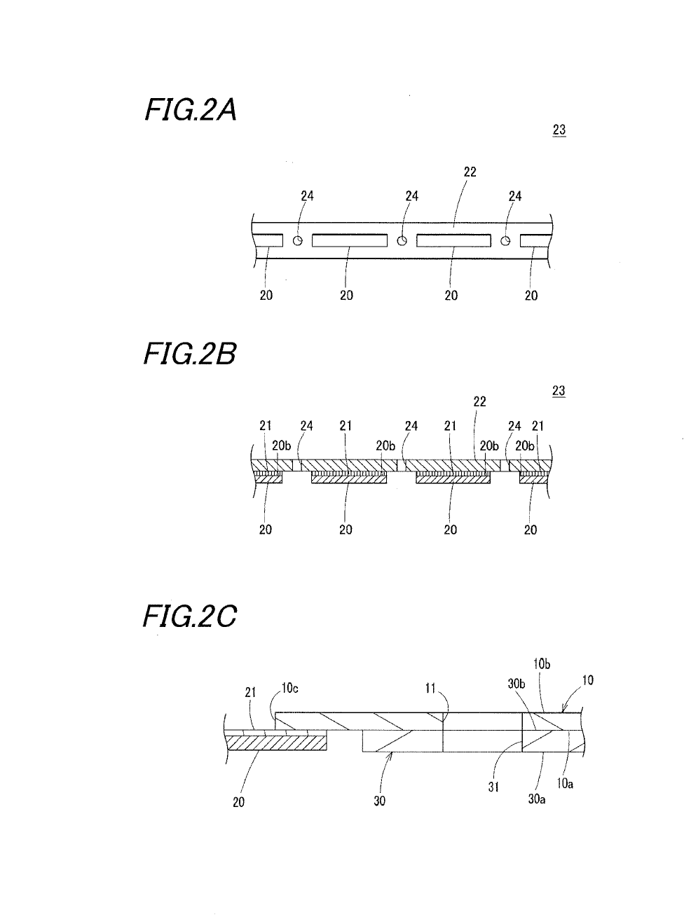

As illustrated in FIGS. 2A and 2B, the piece 20 is formed in a substantially rectangular shape in a plan view and has a plurality of adhesive layers 21 which are formed on the other surface 20b and, for example, temporarily adhere to a long release paper 22 at predetermined intervals in a longitudinal direction. Thus, even when the piece 20 is used after waiting for a long period of time, it is possible to prevent a decrease in adhesive strength of the adhesive layer 21. Further, a strip-like body 23 formed by the piece 20 and the release paper 22 is wound in, for example, a roll shape and is accommodated in a strip-like body accommodating portion (not illustrated) provided on a back side farther than the winding part 70 in the sheet insertion direction X. Further, the piece 20 and/or the release paper 22 of the strip-like body 23 are formed with a plurality of engaging holes 24, which is engaged with an engaging member (not illustrated) for feeding the strip-like body 23, at predetermined intervals in the longitudinal direction.

As illustrated in FIG. 4, the pedestal 30 is made up of, for example, a plate member, and the sheet 10 inserted from the sheet insertion port 1a is placed on the other surface 30b thereof. Thus, the sheet 10 is positioned in a height direction Z. The pedestal 30 has a through-hole 31 formed at a position corresponding to a front end portion 70a of the winding part 70.

As illustrated in FIG. 4, the piece feeding portion 40 is a provided in a release paper conveying path 42 which is disposed at the back side farther than the pedestal 30 in the sheet insertion direction X and is branched from the piece conveying path 41 for connecting the strip-like body accommodating portion and the pedestal 30 to each other. The piece feeding portion 40 is made up of, for example, a pair of conveying rollers and the engaging member for sliding while being engaged with the engaging hole 24 of the strip-like body 23.

For example, when a feeding driving mechanism (not illustrated) is driven in conjunction with a mechanical driving operation to rotate a handle (not illustrated) by a user or an electrical driving operation to press an operation button by a user and drive a driving portion such as a driving motor, the piece feeding portion 40 feeds the strip-like body 23 to the release paper conveying path 42, which is branched from the piece conveying path 41, at a predetermined length, releases the piece 20 from the release paper 22 at a branch point, and thus feeds the released piece 20 to the pedestal 30 from an ejection port 41a of the piece conveying path 41. Specifically, the piece feeding portion 40 is configured to place the piece 20 on the other surface 30b of the pedestal 30 in a state where the adhesive layer 20 is directed toward the sheet 10 as illustrated in FIG. 2C, such that the end on the insertion end side of the sheet 10 overlaps with one end portion of the piece 20 in a plan view. At this time, the piece feeding portion 40 is configured to accommodate the release paper 22, from which the piece 20 is released, in a release paper accommodating portion (not illustrated) communicating with the release paper conveying path 42.

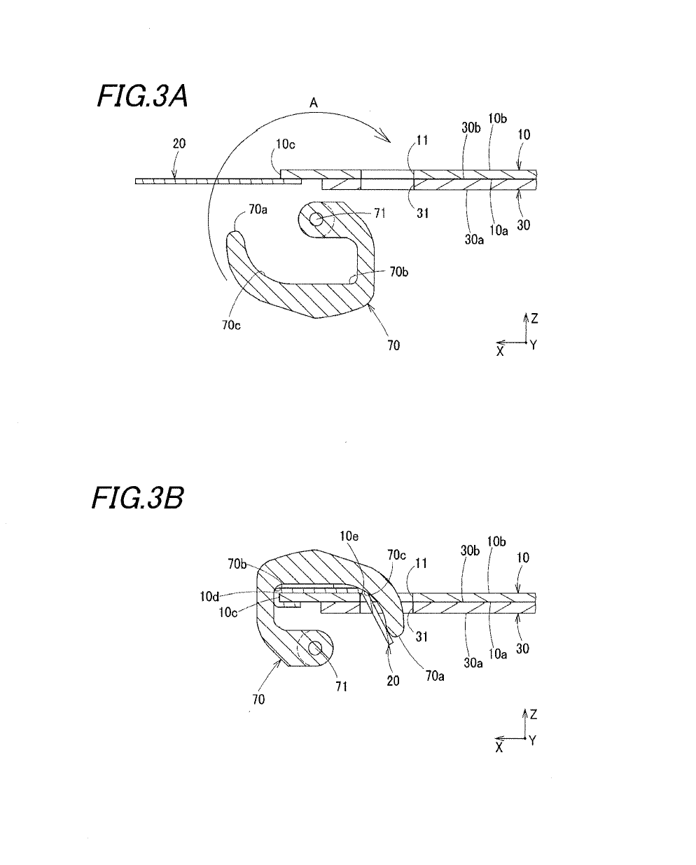

As illustrated in FIG. 4, the winding part 70 is disposed at the back side on the one surface 30a of the pedestal 30 in the sheet insertion direction X. Furthermore, the winding part 70 is disposed to correspond to the through-hole 31 of the pedestal 30 in a width direction Y. As illustrated in FIG. 3A, for example, the winding part 70 is curved or bent in a substantially C-shape, a substantially L-shape, or the like in a side view. The winding part 70 is provided rotatably around a rotation axis 71 substantially parallel to the width direction Y. Specifically, as illustrated in FIG. 3A, the winding part 70 is rotatably provided such that the front end portion 70a rotates toward an end portion of the back side of the pedestal 30 in the sheet insertion direction X, as indicated by an arrow A in FIG. 3A, from a waiting state of being located at the one surface 30a, moves toward the other surface 30b from the one surface 30a of the pedestal 30 through the end portion of the back side in the sheet insertion direction X, and then moves to the through-hole 31 of the pedestal 30 from the end on the back side of the pedestal 30 in the sheet insertion direction X on the other surface 30b.

The winding part 70 is provided such that the other end portion of the piece 20 is wound to the other surface 10b from the one surface 10a of the sheet 10 and is inserted into the hole 11 of the sheet 10 from the other surface 10b of the sheet 10 as illustrated in FIG. 3B, in a manner that the front end portion 70a of the winding part 70 moves toward the other surface 10b from the one surface 10a of the sheet 10 through the end on the insertion end side of the sheet 10 and then rotates to move from the end on the insertion end side of the sheet 10 to the hole 11 of the sheet 10 on the other surface 10b while the front end portion 70a presses the other end portion of the piece 20 of which one end is attached to the one surface 10a of the end on the insertion end side of the sheet 10, as illustrated in FIG. 3A, by a winding part driving mechanism (not illustrated) in conjunction with the mechanical or electrical driving operation. Thereafter, the winding part 70 rotates in a reverse direction by the winding part driving mechanism (not illustrated), and thus the front end portion 70a is provided in a waiting state as positioned at the one surface 30a of the pedestal 30.

As illustrated in FIGS. 3A and 3B, the winding part 70 may be provided such that a base-end-side pressing portion 70b serving as a corner portion (curved portion) of a base end side of an inner periphery of the winding part 70 abuts on a corner portion 10d between the end face 10c of the insertion end side and the one surface 10a of the sheet 10 or the piece 20 corresponding to the corner portion 10d and a front-end-portion-side pressing portion 70c serving as a corner portion (curved portion) of a front end portion side of the inner periphery of the winding part 70 abuts on a corner portion (an edge) 10e between the one surface 10a and the hole 11 of the sheet 10 or the piece 20 corresponding to the corner portion 10e, when the front end portion 70a is inserted into the through-hole 31 of the pedestal 30 from the other surface 30b of the pedestal 30 and the other end portion of the piece 20 is inserted into the hole 11 of the sheet 10 from the other surface 10b of the sheet 10. Thus, the winding part 70 can wind the piece 20 around the sheet 10 having the hole 11 and can press the wound piece 20 using the base-end-side pressing portion 70b and the front-end-portion-side pressing portion 70c, whereby the piece 20 can be reliably attached to the sheet 10.

As illustrated in FIG. 4, the pressing portion 80 is disposed at the foremost side on the other surface 30b of the pedestal 30 in the sheet insertion direction X. For example, the pressing portion 80 is made up of a roller or an elastic piece which is biased toward the pedestal 30. When the sheet 10 wound with the piece 20 by the winding part 70 is pulled out toward the front side in the sheet insertion direction X, the pressing portion 80 presses the sheet 10 and the piece 20 against the pedestal 30 to reliably bond the piece 20 to the sheet 10.

<2. Description of Method of winding Piece Using Piece Winding Device>

A method of winding the piece 20 around the sheet 10 using the piece winding device 1 will be described below.

First, as illustrated in FIG. 4, the piece winding device 1 is configured such that the sheet 10 is inserted toward the back side in the sheet insertion direction X from the sheet insertion port 1a. Then, as illustrated in FIG. 5, the sheet 10 is placed on the other surface 30b of the pedestal 30 in the piece winding device 1. Furthermore, the sheet 10 is positioned in a height direction Z by the pedestal 30.

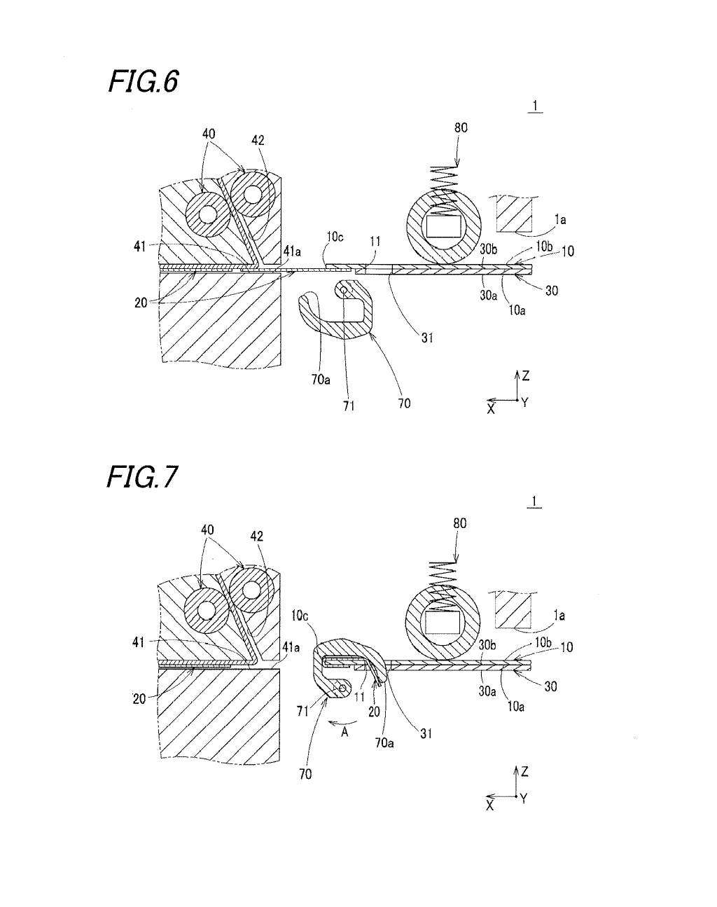

Next, for example, when the piece winding device 1 is mechanically or electrically driven by a user, the strip-like body 23 is fed by the piece feeding portion 40 at a predetermined length as illustrated in FIG. 6, and thus the piece 20 is released from the release paper 22 at the branch point of the piece conveying path 41 and the release paper conveying path 42. The piece winding device 1 is provided such that the piece 20 released from the release paper 22 is fed toward the pedestal 30 by the piece feeding portion 40 in a state where the adhesive layer 21 is directed toward the sheet 10 as illustrated in FIG. 2C and the end on the insertion end side of the sheet 10 overlaps with one end portion of the piece 20 in a plan view. The one surface 10a of the end on the insertion end side of the sheet 10 abuts on the piece 20, and thus the one end portion of the piece 20 can be attached to the one surface 10a of the end on the insertion end side of the sheet 10.

Next, as illustrated in FIG. 7, the piece winding device 1 is provided such that the winding part 70 rotates around the rotation axis 71 substantially parallel to the width direction Y in a direction indicated by an arrow A in FIG. 7. At this time, in the piece winding device 1, the winding part 70 rotates such that the front end portion 70a of the winding part 70 moves toward the other surface 10b from the one surface 10a of the sheet 10 through the end on the insertion end side of the sheet 10 and then moves to the hole 11 of the sheet 10 from the end on the insertion end side of the sheet 10 on the other surface 10b while the front end portion 70a of the winding part 70 presses the other end portion of the piece 20 of which one end is attached to the one surface 10a of the end on the insertion end side of the sheet 10. Thus, the piece winding device 1 is provided such that the other end portion of the piece 20 is wound to the other surface 10b from the one surface 10a of the sheet 10 by the winding part 70 and is inserted into the hole 11 of the sheet 10 from the other surface 10b of the sheet 10. Accordingly, the sheet 10 is wound by the piece 20 over the one surface 10a, the end face 10c on the insertion end side, the other surface 10b, and the hole-edge end face 11a of the hole 11.

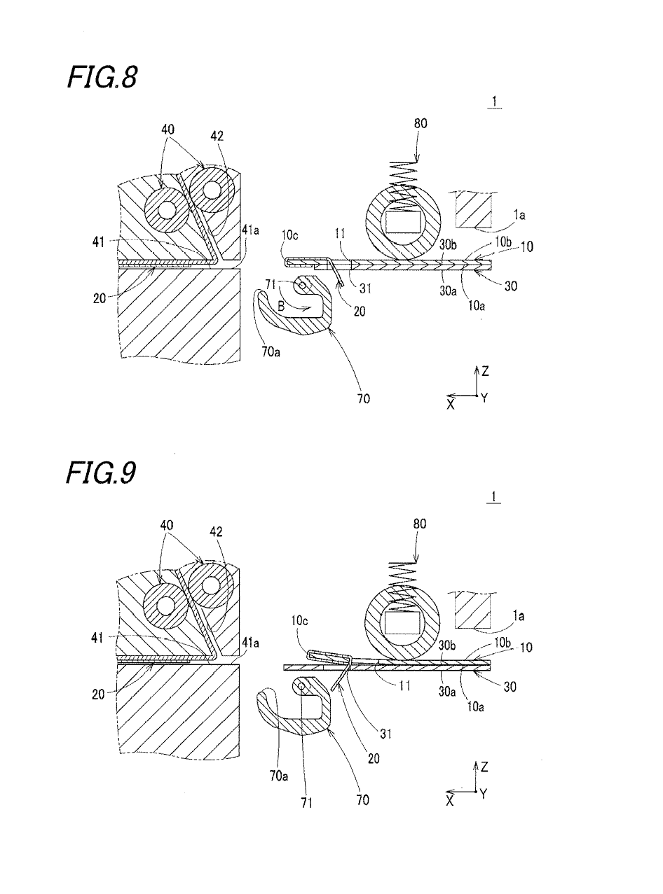

Next, as illustrated in FIG. 8, the piece winding device 1 is provided such that the winding part 70 rotates around the rotation axis 71 substantially parallel to the width direction Y in a direction indicated by an arrow B in FIG. 8 and thus the front end portion 70a returns to the waiting position as disposed on the one surface 30a of the pedestal 30.

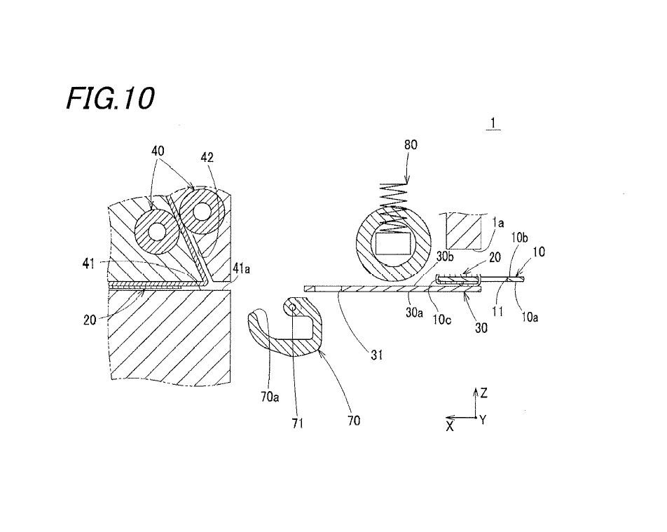

Subsequently, as illustrated in FIG. 9, the piece winding device 1 is provided such that when the sheet 10 wound with the piece 20 is pulled out toward the front side in the sheet insertion direction X, the other end portion of the piece 20 wound around the sheet 10 is wound by being bent toward the one surface 10a of the sheet 10 by the pedestal 30. As illustrated in FIG. 10, the piece winding device 1 is wound to be overlapped on the piece 20 which is wound on the one surface 10a of the sheet 10. Thus, the sheet 10 is circumferentially wound once by the piece 20 over the one surface 10a, the end face 10c on the insertion end side, the other surface 10b, and the hole-edge end face 11a of the hole 11.

Next, as illustrated in FIG. 10, the piece winding device 1 is provided such that when the sheet 10 is further pulled out toward the front side in the sheet insertion direction X, the sheet 10 and the piece 20 are pressed against the pedestal 30 by the pressing portion 80 and thus the piece 20 is attached to the sheet 10.

As described above, the piece winding device 1 is provided such that the sheet 10 having the hole 11 is wound by the piece 20.

<3. Description of Operational effect of Piece Winding Device>

As described above, in the piece winding device 1 according to the present invention, the winding part 70 rotates in such a manner that the front end portion 70a of the winding part 70 moves toward the other surface 10b from the one surface 10a of the sheet 10 through the end on the insertion end side of the sheet 10 and then moves to the hole 11 of the sheet 10 from the end on the insertion end side of the sheet 10 on the other surface 10b while the front end portion 70a of the winding part 70 is pressed against the piece 20 attached to the one surface 10 of the sheet 10 having the hole 11 when the piece 20 is wound around the sheet 10 having the hole 11. Thus, since the piece 20 is wound around the sheet 10 in a manner that the piece 20 attached to the one surface 10a of the sheet 10 having the hole 11 is wound to the other surface 10b from the one surface 10a of the sheet 10 and is inserted into the hole 11 of the sheet 10 from the other surface 10b of the sheet 10, the piece winding device 1 can reliably wind the piece 20 around the sheet 10 with neat finishing without wrinkles or bending damage even in any kind of sheet.

<4. Description of Piece Winding Device according to First Modification Example>

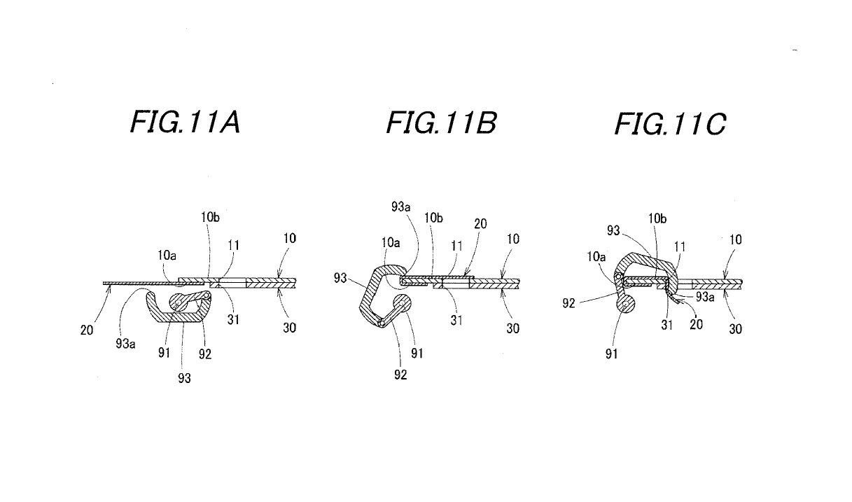

As illustrated in FIG. 11A, a piece winding device 1 may be provided a winding part made up of two members. For example, a winding part 90 made up of two members includes a first winding member 92 provided rotatably around a rotation axis 91 substantially parallel to the width direction Y and a second winding member 93 connected rotatably to the first winding member 92. As illustrated in FIGS. 11B and 11C, for example, the winding part 90 is provided in a substantially C-shape, a substantially L-shape, or the like in a side view, similarly to the winding part 70 as a whole.

Similarly to the winding part 70, the winding part 90 is provided such that the other end portion of a piece 20 is wound to the other surface 10b from one surface 10a of a sheet 10 and is inserted into a hole 11 of the sheet 10 from the other surface 10b of the sheet 10, whereby the piece 20 is wound around the sheet 10, as illustrated in FIGS. 11B and 11C, in a manner that a front end portion 93a of the second winding member 93 moves toward the other surface 10b from the one surface 10a of the sheet 10 through the end on the insertion end side of the sheet 10 and then rotates to move to the hole 11 of the sheet 10 from the end on the insertion end side of the sheet 10 on the other surface 10b while the front end portion 93a of the second winding member 93 presses the other end portion of the piece 20 of which one end is attached to the one surface 10a on the end on the insertion end side of the sheet 10, by a winding part driving mechanism (not illustrated) in conjunction with the mechanical or electrical driving operation as illustrated in FIG. 11A.

As described above, although the winding part 90 is made up of two parts, similarly to the winding part 70 made up of one part, the piece winding device 1 can reliably wind the piece 20 around the sheet 10 with neat finishing without wrinkles or bending damage even in any kind of sheet.

<5. Description of Piece Winding Device according to Second Modification Example>

A piece winding device 1 may be provided with a punch portion, or may not be provided with the punch portion using a sheet 10 formed with the hole 11 in advance by a separate punching device or the like.

<6. Description of Piece Winding Device according to Third Modification Example>

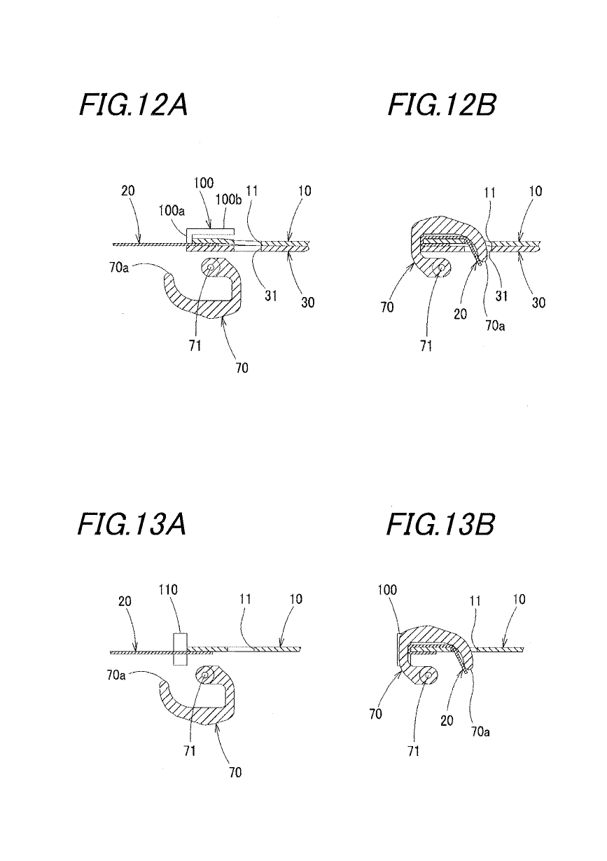

As illustrated in FIG. 12A, a piece winding device 1 may be provided with a positioning member 100 which abuts on an end face 10c on the insertion end side of a sheet 10 to perform the positioning of the sheet 10 on the other surface 30b of a pedestal 30. The positioning member 100 is made up of, for example, a columnar member or a plate member and is provided at a position different from that of the winding part 70 in the width direction Y so as not to disturb the rotation of the winding part 70 (winding part 90). Herein, the positioning member is made up of a substantially L-like plate member and is provided at a back end portion of the other surface 30b of the pedestal 30 in the sheet insertion direction X. Thus, the positioning member 100 performs the positioning of the sheet 10 in the sheet insertion direction X by an abutting portion 100a erected toward the height direction Z, and floating of the end on the insertion end side of the sheet 10 is prevented by a restraining portion 100b provided at an upper end portion of the abutting portion 100a.

As described above, since the piece winding device 1 is provided with the positioning member 100 and thus the sheet 10 can be positioned in the sheet insertion direction X of the sheet 10 in addition to the height direction Z, as illustrated in FIG. 12B, it can reliably wind the piece 20 around the sheet 10 with neat finishing without wrinkles or bending damage even in any kind of sheet.

<7. Description of Piece Winding Device according to Fourth Modification Example>

As illustrated in FIG. 13A, a piece winding device 1 includes a winding part 70 (winding part 90), a piece feeding portion 40 (not illustrated in FIGS. 13A and 13B), and a positioning member 110 which abuts on an end face 10c on an insertion end side of a sheet 10 to perform positioning of the sheet 10, but may not be provided with a pedestal 30, a pressing portion 80, and the like. The positioning member 110 is made up of, for example, a columnar member or a plate member and is provided at a position different from that of the winding part 70 in the width direction Y so as not to disturb the rotation of the winding part 70. Herein, the positioning member is made up of a columnar member and is provided above the winding part 70. Even in such a piece winding device 1, as illustrated in FIG. 13B, a piece 20 can be wound around the sheet 10 having a hole 11.

<8. Description of Piece winding device according to Fifth Modification Example>

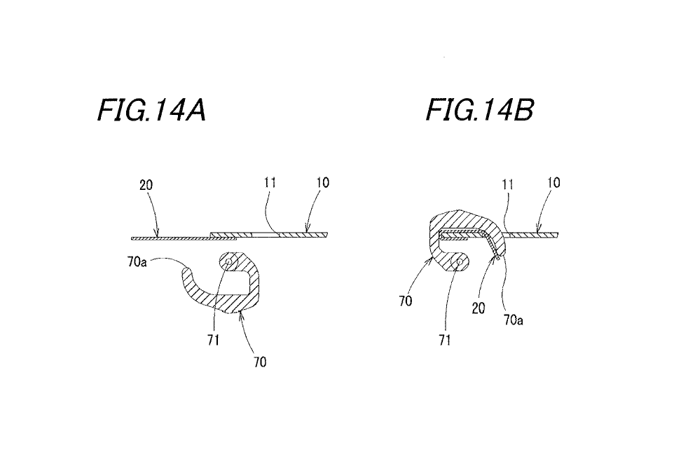

As illustrated in FIG. 14A, a piece winding device 1 may be provided with at least a winding part 70 (winding part 90) and a piece feeding portion 40, but may not be provided with, for example, a pedestal 30 and a pressing portion 80. Even in such a piece winding device 1, as illustrated in FIG. 14B, a piece 20 can be wound around a sheet 10 having a hole 11.

<9. Description of Piece Winding Device according Sixth Modification Example>

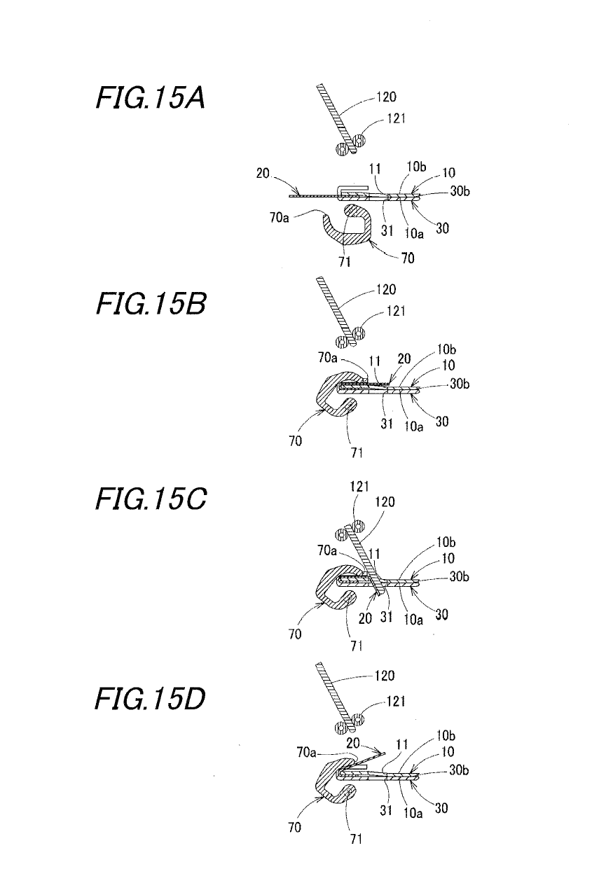

As illustrated in FIGS. 15A to 15C, a piece winding device 1 may be configured to wind a piece 20 around a sheet 10 having a hole 11 with a first winding part 70 and a second winding part 120 without being limited to a configuration in which the piece 20 is wound around the sheet 10 having the hole 11 with only the winding part 70 (winding part 90). That is, the piece 20 may be wound around the sheet 10 by two parts-two steps of rotating the first winding part 70 and driving the second winding part 120, instead of one part-one step of rotating the winding part 70.

As illustrated in FIG. 15A, the second winding part 120 is disposed at a position corresponding to the through-hole 31 of the pedestal 30 which is provided at the other surface 30b of the pedestal 30. Here, the second winding part 120 is disposed to be inclined to the back side in the sheet insertion direction X. Further, the second winding part 120 is made up of, for example, a columnar member (pin member). The second winding part 120 is provided to be movable toward or away from the pedestal 30 by the winding part driving member 121 or the like and is provided to be inserted into the through-hole 31 of the pedestal 30.

When the piece 20 is wound around the sheet 10 having the hole 11, as illustrated in FIG. 15B, first, the piece winding device 1 rotates the winding part 70, and thus the other end portion of the piece 20 attached to one surface 10a of the sheet 10 is wound to the other surface 10b from one surface 10a of the sheet 10 by the winding part 70. Next, as illustrated in FIG. 15C, the piece winding device 1 moves the second winding part 120 to approach the pedestal 30, and thus the other end portion of the piece 20 is inserted into the hole 11 of the sheet 10 from the other surface 10b of the sheet 10 by the second winding part 120. In this way, the piece winding device 1 may be configured such that the piece 20 is wound around the sheet 10 having the hole 11 in two parts-two steps.

The piece winding device 1 is not limited to the configuration as illustrated in FIG. 15B in which after the other end portion of the piece 20 is wound by the winding part 70, the second winding part 120 is moved to approach the pedestal 30 and thus the other end portion of the piece 20 is inserted into the hole 11 of the sheet 10 from the other surface 10b of the sheet 10, but may have a configuration as illustrated in FIG. 15D in which when the other end portion of the piece 20 is wound around the other surface 10b of the sheet 10 by the winding part 70, the second winding part 120 is moved to approach the pedestal 30 and thus the other end portion of the piece 20 is inserted into the hole 11 of the sheet 10 from the other surface 10b of the sheet 10.

<10. Description of Piece Winding Device according to Seventh Modification Example>

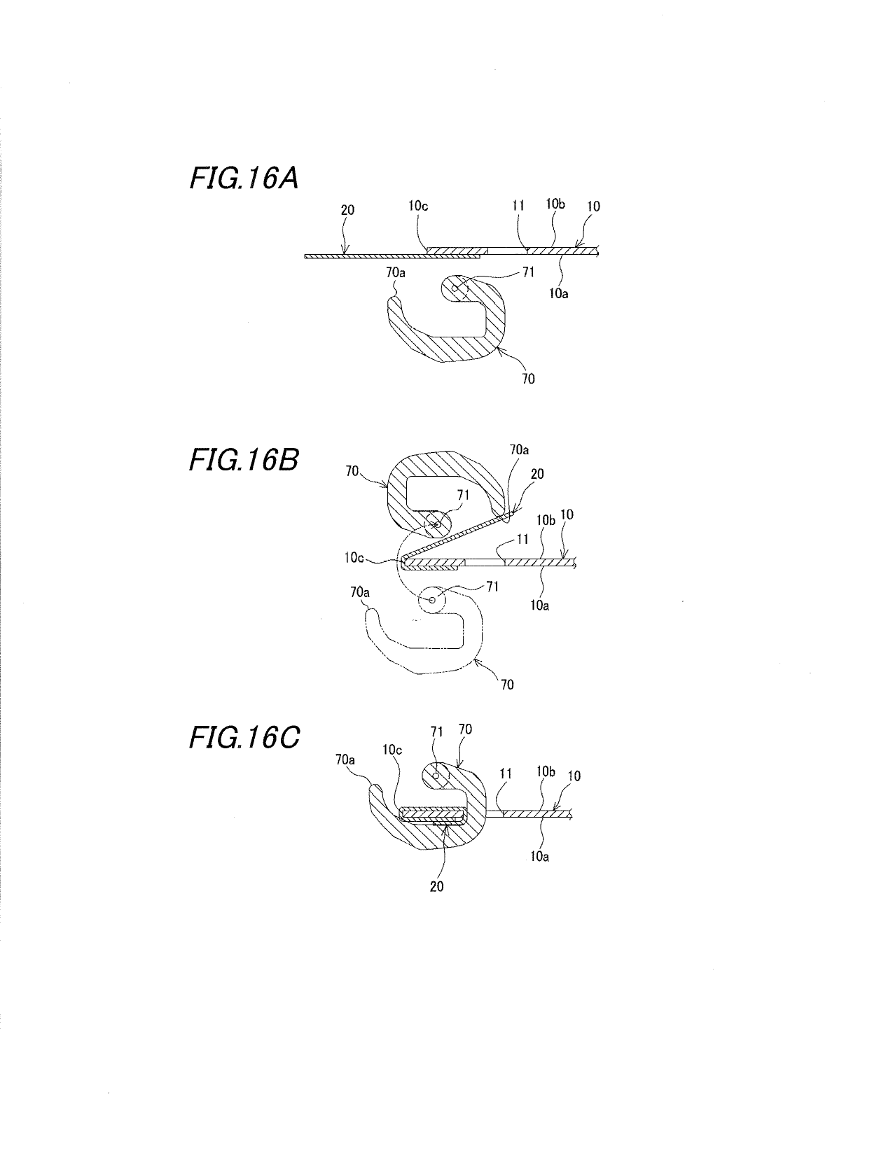

The piece winding device 1 may be provided such that the winding part 70 is provided to be movable from the one surface 10a of the sheet 10 to the other surface 10b as illustrated in FIGS. 16A to 16C.

Specifically, first, the winding part 70 is rotated by the winding part driving member (not illustrated) in conjunction with the mechanical or electrical driving operation from a first waiting state where the winding part is disposed on the one surface 10a of the sheet 10 and a front end portion 70a is positioned on the one surface 10a of the sheet 10 as illustrated in FIG. 16A. As illustrated in FIG. 16B, the front end portion 70a moves from the one surface 10a of the sheet 10 toward the other surface 10b through an end portion of an insertion end side of the sheet 10 while pressing the other end portion of the piece 20 of which the one end is attached to the one surface 10a of the end on the insertion end side of the sheet 10. Thus, the winding part 70 winds the other end portion of the piece 20 from the one surface 10a of the sheet 10 to the other surface 10b through the end on the insertion end side of the sheet 10. Next, the winding part 70 is rotated in a reverse direction by the winding part driving member (not illustrated), and returns to the first waiting state.

Next, as illustrated in FIG. 16B, a winding part moving member (not illustrated) causes the winding part 70 to move from the first waiting state to a second waiting state where the winding part is disposed on the other surface 10a of the sheet 10 and the front end portion 70a is positioned on the other surface 10a of the sheet 10 in such a manner that, for example, a rotation axis 71 moves from the one surface 10a toward the other surface 10b of the sheet 10. At this time, while the winding part 70 rotates around the rotation axis 71 by a predetermined angle from the first waiting state, the rotation axis 71 moves in an arc shape, a U shape, or a C shape to bypass from the sheet 10. For example, the winding part 70 is not limited thereto. The winding part rotates around the rotation axis 71 by 180 degrees from the first waiting state, so that the rotation axis 71 moves in the arc shape and moves to a position symmetrical about an arbitrary point.

Next, the winding part 70 moved toward the other surface 10b of the sheet 10 is rotated by the winding part driving member (not illustrated) from the second waiting state, and thus the front end portion 70a moves from the other surface 10b of the sheet 10 toward the one surface 10a through the hole 11 of the sheet 10 as illustrated in FIG. 16C while pressing the other end portion of the piece 20 wound from the one surface 10a to the other surface 10b. In this way, the winding part 70 winds the other end portion of the piece 20 from the other surface 10b to the one surface 10a of the sheet 10 through the hole 11 of the sheet 10. Subsequently, after being rotated in the reverse direction by the winding part driving member (not illustrated) to return to the second waiting state, the winding part 70 moves from the other surface 10b toward the one surface 10a of the sheet 10 by the winding part moving member (not illustrated) and returns to the first waiting state.

As described above, the piece winding device 1 can reliably wind the piece 20 around the sheet 10 with neat finishing without wrinkles or bending damage even when the winding part 70 is provided to be movable from the one surface 10a toward the other surface 10b of the sheet 10.

When being on the one surface 10a of the sheet 10, the winding part 70 may wind the other end portion of the piece 20 from the one surface 10a of the sheet 10 to the hole 11 through the end on the insertion end side of the sheet 10 and the other surface 10b. Thereafter, when moving toward the other surface 10a of the sheet 10, the winding part 70 may wind the other end portion of the piece 20 from the hole 11 to the one surface 10a of the sheet 10.

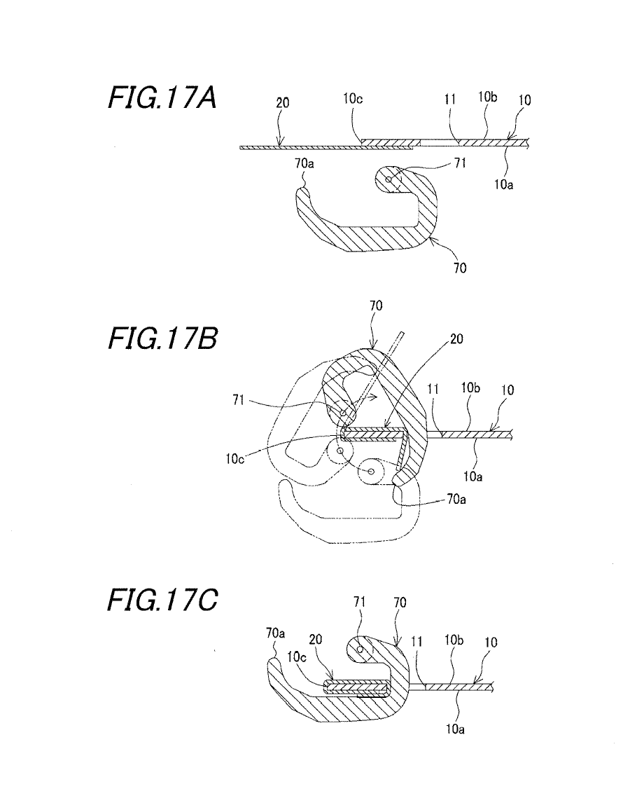

The winding part 70 is not limited to the configuration in which the winding part winds the piece 20 attached to the one surface 10a of the sheet 10 from the one surface 10a of the sheet 10 to the other surface 10b, and then moves from the one surface 10a toward the other surface 10b of the sheet 10 to insert the piece into the hole 11 from the other surface 10b of the sheet 10. As illustrated in FIGS. 17A to 17C, the winding part may wind the piece 20 attached to the one surface 10a of the sheet 10 from the one surface 10a to the other surface 10b of the sheet 10 while moving from the one surface 10a toward the other surface 10b of the sheet 10, thereby inserting the piece into the hole 11 from the other surface 10b of the sheet 10.

Specifically, first, the winding part 70 moves from the one surface 10a toward the other surface 10b of the sheet 10 as illustrated in FIG. 17B by the winding part moving member (not illustrated) from the first waiting state as illustrated in FIG. 17A. At the same time, the winding part 70 is rotated the winding part driving member (not illustrated), and the front end portion 70a moves from the one surface 10a toward the other surface 10b of the sheet 10 through the end on the insertion end side of the sheet 10 while pressing the other end portion of the piece 20 of which the one end is attached to the one surface 10a of the end on the insertion end side of the sheet 10 and moves from the end on the insertion end side of the sheet 10 to the hole 11 of the sheet 10 on the other surface 10b as illustrated in FIG. 17B. As illustrated in FIG. 17C, the front end portion 70a of the winding part 70 moves from the hole 11 of the sheet 10 toward the one surface 10a of the sheet 10. Through such a series of motions, the winding part 70 winds the other end portion of the piece 20 from the one surface 10a to the other surface 10b of the sheet 10 through the end on the insertion end side of the sheet 10, and then further winds the other end portion of the piece from the other surface 10b to the one surface 10a of the sheet 10 through the hole 11 of the sheet 10. Next, the winding part 70 is rotated by the winding part moving member (not illustrated) and the winding part driving member (not illustrated) in the reverse direction, and returns to the first waiting state.

As described above, the piece winding device 1 can reliably wind the piece 20 around the sheet 10 with neat finishing without wrinkles or bending damage even when the winding part 70 is provided to be movable from the one surface 10a toward the other surface 10b of the sheet 10 and rotates around the rotation axis 71 to wind the piece 20 around the sheet 10 while moving from the one surface 10a to the other surface 10b of the sheet 10.

<11. Description of Piece Winding Device according to Eighth Modification Example>

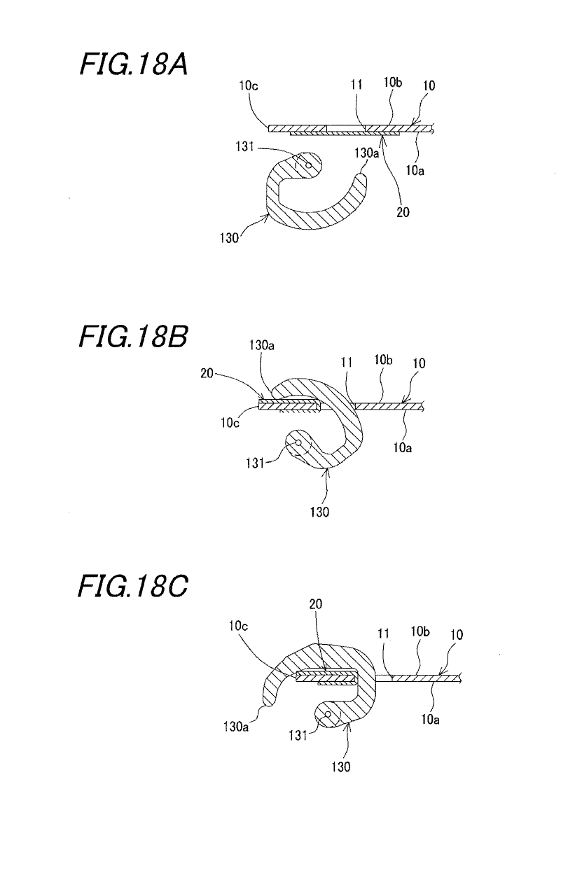

A piece winding device 1 may include a winding part 130, as illustrated in FIGS. 18A to 18C, which rotates such that a front end portion 130a moves from a hole 11 of a sheet 10 to an end on an insertion end side of the sheet 10 while pressing a piece 20 when the piece 20 is wound around the sheet 10, in place of the winding part 70 which rotates such that the front end portion 70a moves from the end on the insertion end side of the sheet 10 to the hole 11 of the sheet 10 while pressing the piece 20 when the piece 20 is wound around the sheet 10.

The winding part 130 has substantially the same configuration as that of the winding part 70 except for being disposed on the back side in the sheet insertion direction X and on the one surface 10a of the sheet 10 such that a front end portion 130a is directed toward the front side in the sheet insertion direction X as illustrated in FIG. 18A and being different from each other in a rotation direction. The front end portion 70a of the winding part 70 moves in this order of the one surface 10a of the sheet 10, the end on the insertion end side, the other surface 10b, and the hole 11, whereas the front end portion 130a of the winding part 130 moves in this order of the one surface 10a, the hole 11, the other surface 10b, and the end on the insertion end side.

Specifically, as illustrated in FIG. 18A, first, the winding part 130 is rotated by a winding part driving member (not illustrated) in conjunction with the mechanical or electrical driving operation from a waiting state where the winding part is disposed on the one surface 10a of the sheet 10 and the front end portion 130a is positioned on the one surface 10a of the sheet 10. As illustrated in FIG. 18B, the front end portion 130a moves from the one surface 10a toward the other surface 10b of the sheet 10 through the hole 11 of the sheet 10 while pressing the one end portion of the piece 20 which is attached to the one surface 10a of the end on the insertion end side of the sheet 10. As illustrated in FIG. 18C, on the other surface 10b, the front end portion 130a of the winding part 70 moves from the hole 11 of the sheet 10 to the end on the insertion end side of the sheet 10. Through such a series of motions, the winding part 130 winds the one end portion of the piece 20 over three surfaces from the one surface 10a to the other surface 10b of the sheet 10 through the hole 11. Next, the winding part 130 is rotated in a reverse direction by the winding part driving member (not illustrated) and returns to the waiting state.

As described above, the piece winding device 1 can reliably wind the piece 20 around the sheet 10 with neat finishing without wrinkles or bending damage even when including the winding part 130 which is rotated such that the front end portion 130a is rotated from the hole 11 of the sheet 10 to the end side on the insertion end side of the sheet 10 while pressing the piece 20 when the piece 20 is wound to the sheet 10.

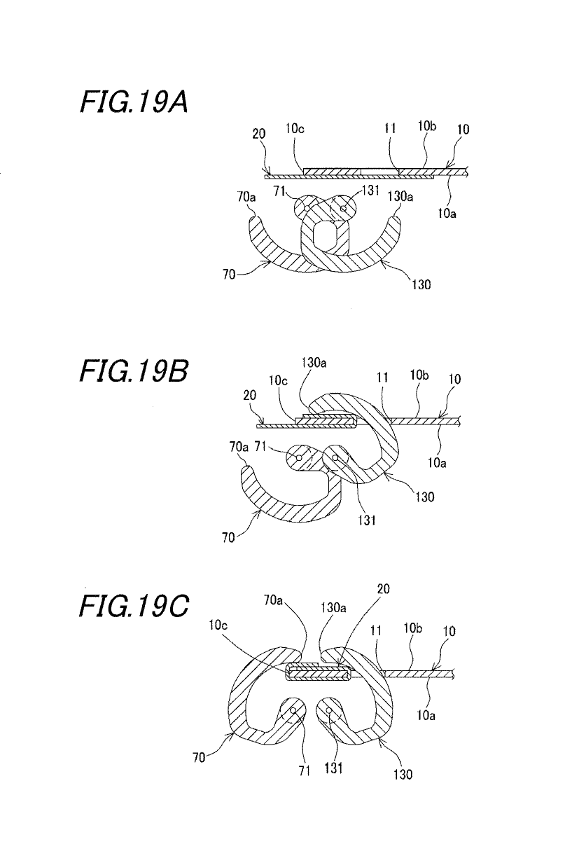

As illustrated in FIGS. 19A to 19C, in addition to the winding part 130 which is rotated such that the front end portion 130a is rotated from the hole 11 of the sheet 10 to the end side on the insertion end side of the sheet 10 while pressing the piece 20 when the piece 20 is wound to the sheet 10, the piece winding device 1 may include the winding part 70 which is rotated in a direction different from the winding part 130 such that the front end portion 70a moves from the end side on the insertion end side of the sheet 10 to the hole 11 of the sheet 10 while pressing the piece 20 when the piece 20 is wound to the sheet 10.

Specifically, as illustrated in FIG. 19A, first, the winding part 130 is rotated by a winding part driving member (not illustrated) from a waiting state where the winding part is disposed on the one surface 10a of the sheet 10 and the front end portion 130a is positioned on the one surface 10a of the sheet 10. As illustrated in FIG. 19B, the front end portion 130a moves from the one surface 10a toward the other surface 10b of the sheet 10 or the end on the insertion end side of the sheet 10 through the hole 11 of the sheet 10 while pressing one end portion of the piece 20 which is attached to the one surface 10a of the end on the insertion end side of the sheet 10. Thus, the winding part 130 winds the one end portion of the piece 20 from the one surface 10a to the other surface 10b of the sheet 10 through the hole 11. Next, the winding part 130 rotates in a reverse direction by the winding part driving member (not illustrated), and returns to the waiting state.

Subsequently, as illustrated in FIG. 19B, the winding part 70 is rotated by a winding part driving member (not illustrated) from the waiting state where the winding part is disposed on the one surface 10a of the sheet 10 and the front end portion 70a is positioned on the one surface 10a of the sheet 10. Then, as illustrated in FIG. 19C, the front end portion 70a moves from the one surface 10a toward the other surface 10b of the sheet 10 or the hole 11 of the sheet 10 through the end on the insertion end side of the sheet 10 while pressing the other end portion of the piece 20. In this way, the winding part 70 winds the other end portion of the piece 20 from the one surface 10a to the other surface 10b of the sheet 10 through the end on the insertion end side of the sheet 10. Thereafter, the winding part 70 is rotated in a reverse direction by the winding part driving member (not illustrated), and returns to the waiting state.

As described above, the piece winding device 1 can reliably wind the piece 20 around the sheet 10 with neat finishing without wrinkles or bending damage even when including the winding part 130 which rotates such that the front end portion 130a moves from the hole 11 of the sheet 10 to the end on the insertion end side of the sheet 10 while pressing the piece 20, and the winding part 70 which rotates in a direction different from the winding part 130 such that the front end portion 70a moves from the end on the insertion end side of the sheet 10 to the hole 11 of the sheet 10 while pressing the piece 20.

The piece winding device 1 is not limited to the configuration in which the winding part 70 rotates after the winding part 130 rotates, but may have a configuration in which the winding part 130 rotates after the winding part 70 rotates. The piece winding device 1 may be configured such that one winding part rotates before the other winding part rotated in advance returns completely to the waiting state.

Although one or more embodiments of the present invention have been described in detail, it should be understood that the various changes, substitutions, and alterations could be made hereto without departing from the spirit and scope of the invention.

This application is based upon and claims the benefit of priority of the prior Japanese Patent application No. 2013-225349, filed on Oct. 30, 2013, and the prior Japanese Patent application No. 2014-089403, filed on Apr. 23, 2014, the entire contents of which are incorporated herein by reference.

### REFERENCE SIGNS LIST

1: piece winding device
1a: sheet insertion port
10: sheet
10a: one surface
10b: the other surface
10c: end face
10d: corner portion
10e: corner portion
11: hole
11a: hole-edge end face
20: piece
20b: the other surface
21: adhesive layer
22: release paper
23: strip-like body
24: engaging hole
30: pedestal
30a: one surface
30b: the other surface
31: through-hole
40: piece feeding portion
41: piece conveying path
41a: ejection port
42: release paper conveying path
70: winding part
70a: front end portion
70b: base-end-side pressing portion
70c: front-end-portion-side pressing portion
71: rotation axis
80: pressing portion
90: winding part
91: rotation axis
92: first winding member
93: second winding member
93a: front end portion
100: positioning member
100a: abutting portion
100b: restraining portion
110: positioning member
120: second winding part
121: winding part driving member
130: winding part
130a: front end portion

1. A piece winding device that is configured to wind a piece attached to one surface of a sheet having a hole so as to wind the piece from the one surface to the other surface of the sheet through an end surface of the sheet and to insert the piece into the hole from the other surface of the sheet.

2. A piece winding device characterized by comprising: a winding part that, when winding a piece around a sheet having a hole, rotates such that a front end portion of the winding part moves from an end portion of the sheet to the hole of the sheet while the front end portion presses the piece.

3. The piece winding device according to claim 2, wherein the winding part is provided to be movable from one surface to the other surface of the sheet, and after winding the piece attached to the one surface of the sheet from the one surface to the other surface of the sheet, the winding part moves from the one surface of the sheet to the other surface to insert the piece into the hole from the other surface of the sheet.

4. The piece winding device according to claim 2, wherein the winding part is provided to be movable from one surface to the other surface of the sheet, and the winding part is configured to wind the piece attached to the one surface of the sheet from the one surface to the other surface of the sheet to insert the piece into the hole from the other surface of the sheet while the winding part moves from the one surface to the other surface of the sheet.

5. The piece winding device according to claim 1, wherein the piece has an adhesive layer.

6. The piece winding device according to claim 1, further comprising: a positioning member by which the sheet is positioned.

7. The piece winding device according to claim 1, further comprising: a pressing member that presses the sheet wound with the piece.

8. A piece winding device comprising: a winding part that, when winding a piece around a sheet having a hole, rotates such that a front end portion of the winding part moves from the hole of the sheet to an end portion of the sheet while the front end portion presses the piece.

9. The piece winding device according to claim 8, further comprising: another winding part that rotates such that a front end portion of said another winding part moves from the end portion of the sheet to the hole of the sheet while said another winding part presses the piece.

10. The piece winding device according to claim 2, wherein the piece has an adhesive layer.

11. The piece winding device according to claim 2, further comprising: a positioning member by which the sheet is positioned.

12. The piece winding device according to claim 2, further comprising: a pressing member that presses the sheet wound with the piece.
